(19) United States
(12) Patent Application Publication
(10) Pub. No.: US 2020/0211405 A1
(43) Pub. Date: Jul. 2, 2020

(54) APPARATUS AND METHOD FOR EDUCATING CHILDREN

(71) Applicant: Heidi Everley, Saginaw, TX (US)

(72) Inventor: Heidi Everley, Saginaw, TX (US)

(21) Appl. No.: 16/237,614

(22) Filed: Dec. 31, 2018

(51) Int. Cl. G09B 1/06; G09B 17/00

(52) U.S. Cl. CPC G09B 1/06; G09B 17/00

(57) ABSTRACT

A apparatus and method for educating children is presented. The apparatus and method have an object, such as clothing articles, dishware, bedding articles, etc. The word representing the object is chosen and attached to the object, then an animal is selected and attached to the object. The child then must choose the appropriate word for the chosen picture and attach to the object. Thus, the lesson has been completed.

### FIELD OF THE INVENTION

This invention relates to methods and apparatus for education. More particularly, it relates to method and apparatus which are educating children using pictures and words.

### BRIEF SUMMARY OF THE INVENTION

The invention is a line of educational items that may enable parents to teach their children using everyday items. It may come in kit form and may enable parents and families to create matched sets of clothing, bedding, or other products using stamps, inks (ink pad and ink container) and/or screens. The invention may help children learn to read, form sentence structures and match symbols, shapes, etc. Other benefits of the invention include incorporating learning into everyday activities, into art classroom settings, birthday parties, Do-It-Yourself projects and family fun. It may allow children to start learning at a younger age through basic repetition such as getting dressed every day. The kit may be producible in a variety of designs. For example, an “Animals” kit may include stamps, stencils, screens, and the clothing items on which the designs and words would be applied. A package could include four pairs of socks and four panties/four bras (for girls) or four boxers or underwear (for boys). The kits may be customized for age and gender. Each item may have room to add a picture of the animal and the matching word (for example, a picture of a dog and the word, “DOG”). Other animals with this pack may include a duck, cat, and turtle. Therefore, each of the four items in a set may be stamped/stenciled/screened with a different animal, word, and color. The child may then match the clothing items using the color, animal, and word when getting dressed. In expansion packs, other animals could also be offered, including birds, butterflies, dolphins, etc. The kit may also be offered in a bedding set. Other sets may include plastic dishware (cup, plate, dish, bowl), or baby apparel and other products (bibs, onesies, bottles). Themes may include the alphabet, emotions, colors, flowers, symbols, shapes, safety, money, weather, food, holidays, and more. With all the themes, designs/pictures and matching words may be included in the same quantity as the number of each item in the kit. All items may have a logo including the word, “MY” preceding the name of the item. On-line ordering may be available to the consumer to allow for customization of the kit.

### BACKGROUND

Various articles of apparel have been used to assist in education, particularly for education of infants, toddlers, and children.

For example, an apron worn by a teacher having pockets of different colors removably attached to the apron. The pockets are of various colors for the teaching of color identification. Color identification is taught to young children by the teacher placing articles of a matching color into a pocket while the children observe.

Further, there has been presented a cape that is worn by a teacher and is used to teach the spelling of words. The cape has a number of pockets on the front of the cape, each pocket displaying a different consonant of the alphabet. Inside each pocket is an object which corresponds to the consonant of the pocket. Detachable patches displaying the vowels of the alphabet are attached to the front of the cape.

In another attempt, a mother's bib with detachable multicolored two-dimensional infant toys to aid supervised baby play. The bib may be worn by an adult for interactive play with a young child. The bib has a number of two-dimensional appliques for attachment and detachment by the child. The appliques include the letters of the alphabet, a variety of fastening devices, and toys that make sounds.

Similarly described, a child's activity bib which is designed to be worn by an adult while the child is held on the lap of the adult facing the activity bib. The activity bib has a number of activity means mounted on the front of the bib. These activity means may include a color activity, a texture activity, a shape activity, a number activity, and a pocket activity.

Other attempts at educational children's clothing include where the article of clothing is a garment having a plurality of pockets. Each of the pockets displays at least one member of an educational concept and contains a removable object displaying the educational concept. Each of the removable objects is secured to one of the pockets to prevent disassociation of the objects from the garment.

The articles of apparel described above are generally designed to be worn by an adult for instructive play with infants, toddlers, or children, and include detachable pockets and/or removable articles for teaching alphabet, color, texture, shape, numbers, sounds, spelling, etc.

### BRIEF DESCRIPTION OF THE DRAWINGS

FIG. 1 is a view of an exemplary tags and objects.

FIG. 2 is a first stage of an exemplary example of teaching experience with the exemplary tags and objects.

FIG. 3 is a second stage of an exemplary example of teaching experience with the exemplary tags and objects.

FIG. 4 is a third stage of an exemplary example of teaching experience with the exemplary tags and objects.

FIG. 5 is a final stage of an exemplary example of teaching experience with the exemplary tags and objects.

FIG. 6 is a flowchart of the exemplary teaching experience.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

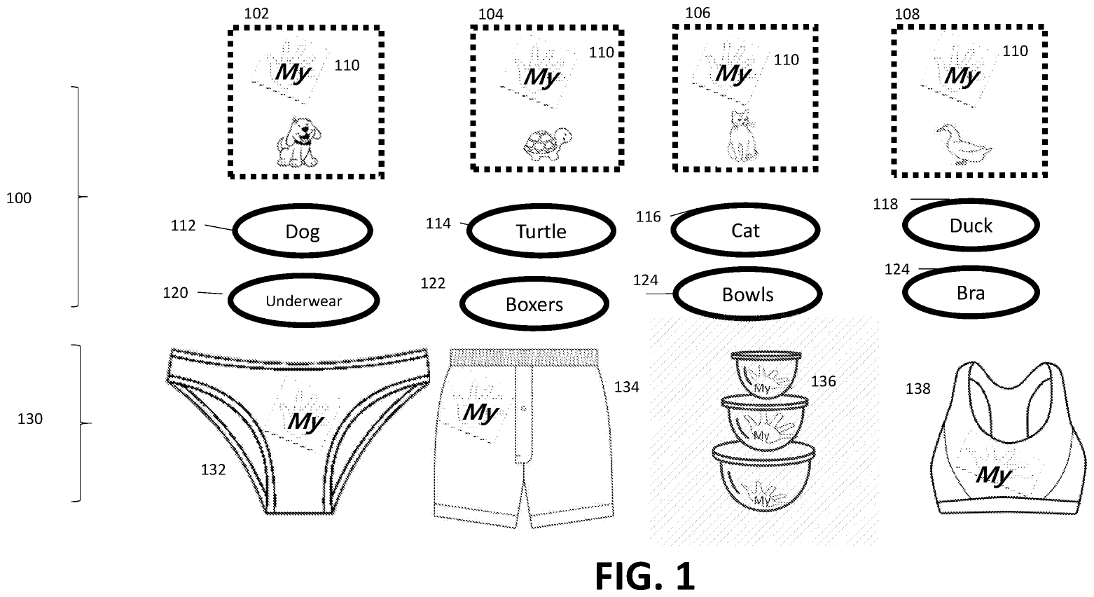

Referring to FIG. 1, is a view of the exemplary tags 100 and objects 130. The tags 100 are stamps 102, 104, 106, 108, 110, 112, 114, 116, 118, 120, 122, 124 and are representative of objects and other word and picture combination to be taught to children. The stamps 102 are represented as stamps in this example but may be stencils, stamps, screens, stickers, etc.

The stamps 102, 104, 106, 108 have a logo 110 and a picture 112, 114, 116, 118 such as a dog 112, a turtle 114, a cat 116, and a duck 118. Although picture 112, 114, 116, 118 are pictures of animals, the picture may be emotions, colors, flowers, symbols, safety signs, money, weather, food, vehicles of transportation (trains, planes, cars, bikes), etc.

The pictures 112, 114, 116, 118 have corresponding word identifiers 120, 122, 124, 126, where the words are dog 112, turtle 114, cat 116, duck 120. The word identifiers are representative of the pictures that are shown but may be any animal, emotion, color, flower, symbols, safety signs, money, weather, food, etc. The words may be words include other words like blue, smile, blue, stop sign, penny, rain, hamburger, etc. but may include any word in the language of the child. The words may also be in languages other than the child's first language to help teach a foreign language to the child. The word identifiers may be stencils, stamps, screens, etc. Further, the word identifiers may be in any language and may also represent any type of picture that would be taught to a child.

The object tags 120, 122, 124, 126 represent an object being taught. The type of information or words contained on the tags 120, 122, 124, 126 are underwear 120, boxers 122, bowls 124 and bra 126. Though these are the words used for the objects to be used in this example, they may contain words that represent the objects being used to teach a child a language or what the correct word is for an object or how to put clothing together properly, etc. The object tags may be stencils, stamps, screens, etc. Further, the object tags may be in any language and may also represent any type of object that would be taught to a child.

The example objects 130 are underwear 132, boxers 134, bowls or Tupperware 136 and bra 138. The would correspond to the object tags 120, 122, 124, 126. The object 130 may any type of object or set of objects that would be educational and may include, but not limited to, clothing (such as underwear, boxers, bra, pants, shirt, dress, etc.), emotions (such as happy, sad, silly, angry, etc), colors (such as blue, green, red, black, etc.), flowers (such as dandelion, rose, tulip, hibiscus, etc), symbols (such as triangle, rectangle, square, etc.), safety (such as stop sign, yield sign, police car, fire truck, etc.), money (such as penny, nickel, dime, quarter, dollar, etc.), weather (such as snowflake, rain, lightning, etc.), food (such as hamburger, hotdog, bread, etc.).

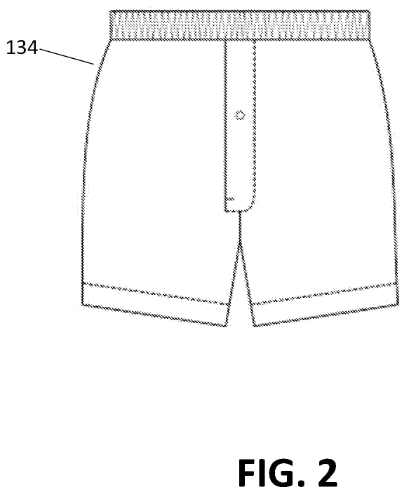

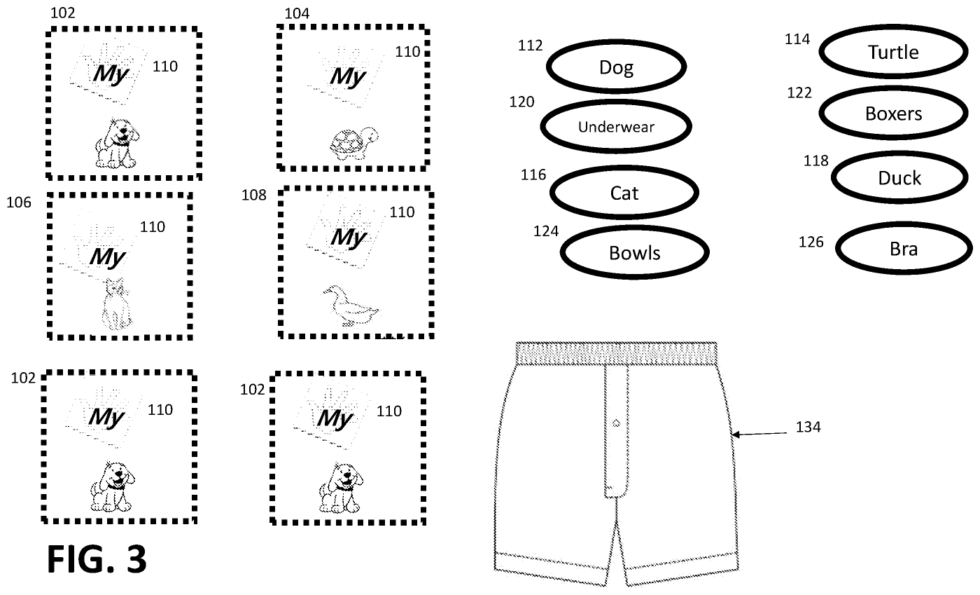

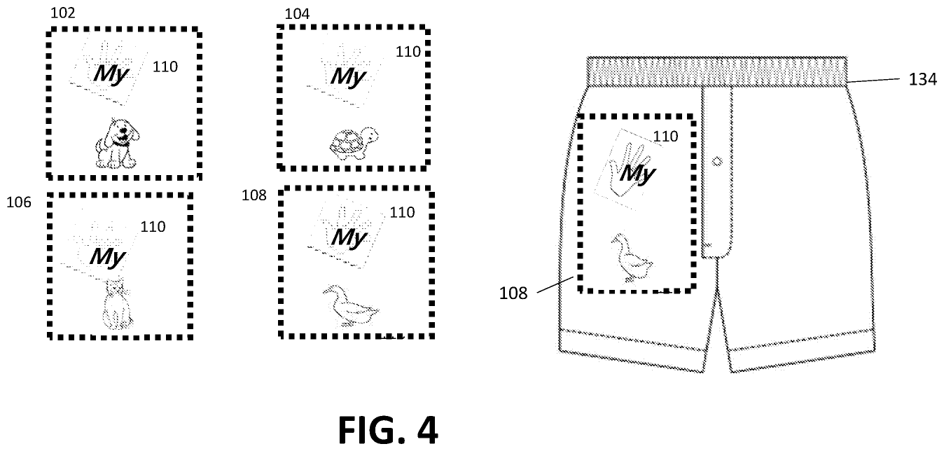

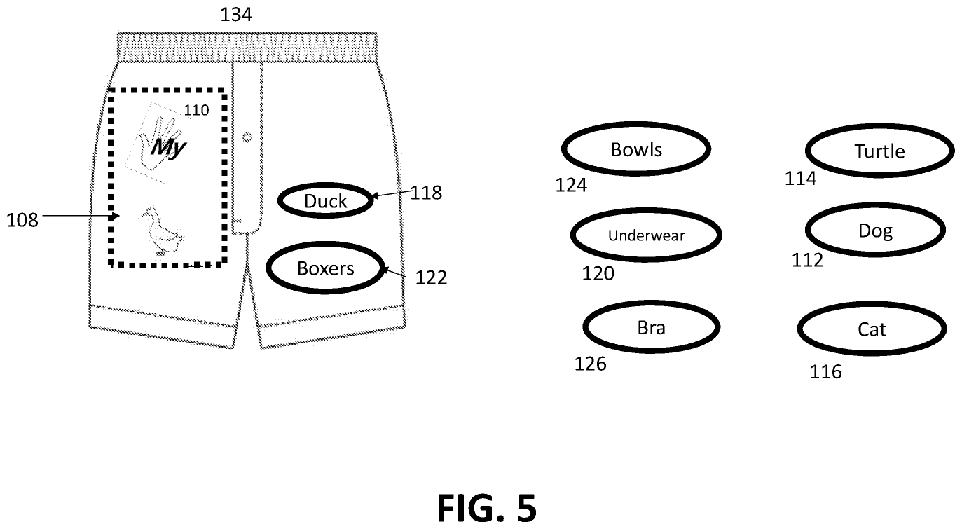

Moving now to FIG. 2, FIG. 3, FIG. 4 and FIG. 5, an example of the use of the tags 110 and objects is shown. Boxers 134 are shown as the object 130 to be taught to the child.

In FIG. 2, the child is presented with a picture of a dog 102, a turtle 104, a cat 106 and a duck 108. The child is presented with an object 130 where the object 130 is a pair of boxers 134.

The child selects the picture of a duck 108 and places the stencil of the duck 108 onto the boxers 134. The child then in FIG. 4, the may place one or more pictures of the duck 108 onto the boxers 134. The pictures further have a logo 110 to indicate the brand or may be a logo consistent with the child so the child would remember which of the objects 130 would be their objects

Moving now to FIG. 5, the child selects the word identifier 108 relative to the picture 108 that was chosen and placed on the boxers 134. The word identifier for duck 118 is placed on the boxers 134 to show the relationship of the picture of the duck 108 and the word identifying duck 118.

Next in FIG. 5, the child selects the object tag 122 that represents the boxers 134 as being the selected object 130. The child selects the word identifier “boxers” 122. Once the child has been determined to have chosen the correct word identifier, the object tag “boxers” is attached to the boxers 134. The child may then be moving to the next object and being taught what objects may be put together.

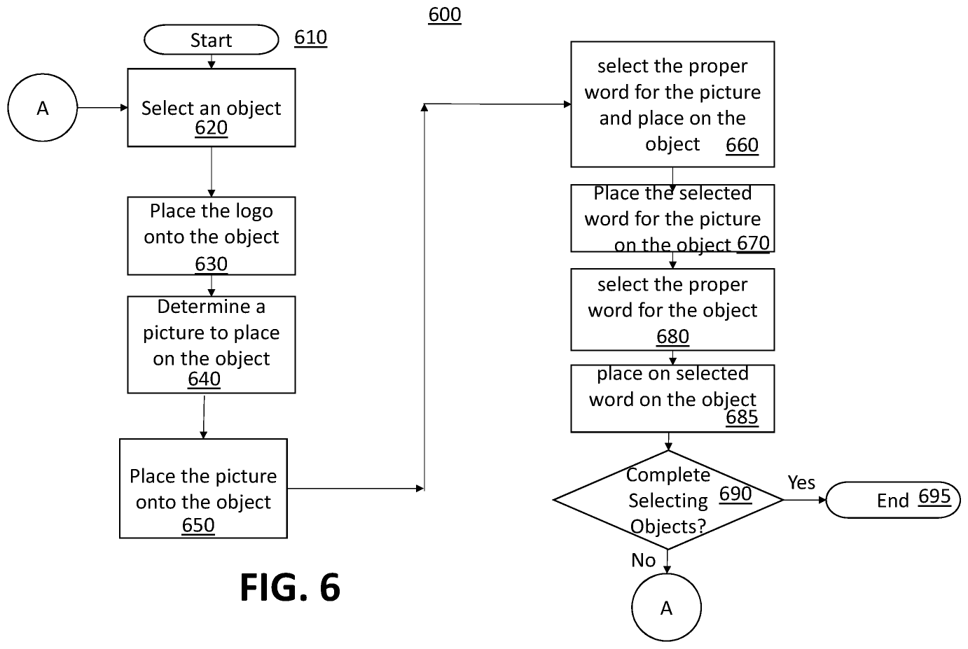

Now in FIG. 6, a flowchart 600 of the education is shown. The process starts at the Start 610. An object 130 is selected at 620. The object 130 may be any object that one wants to teach to a child. The example being a pair of boxers 134. The object 130 may be any object 130 that may be taught to a child.

At 630 he child selects an object tag 120, 122, 124, 126 that is the correct word for the object 130 and puts the object tag on the object 130. At 640, a picture 108 is chosen and is placed on the object 130.

The child, at 650, then determines the correct word identifier 118 for the picture 108. After the parent or teacher validates the selection, the child places the word identifier 118 on the object 130.

At 670, it is determined whether this is the last object 130 to be selected. If this is the last selection of an object 130, then the lesson ends at 680.

If it is determined at 670 that this is not the last object 130 to be taught, then the lesson returns to selecting an object at 620. The lesson may continue to teach other objects related or not related and may include teaching in other languages.

The lesson may further continue to use objects 130 that are closely related and to teach what goes together. In some cases, like clothing, it may be what items of clothing go together or may also be used to teach what colors are appropriate to wear together.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for teaching children, the apparatus comprising:
an object, where the object is to be labeled;
an object tag, wherein the object tag being an identifier of the object;
a picture, wherein the picture is attachable to the object;
a word identifier, wherein the word identifier identifies the picture; and
wherein the object tag, the picture and the word identifier are coupled to the object when the object tag has been correctly chosen to identify the object, the picture and the word identifier coupled to the object when the word identifier correctly identifies the picture.

2. The apparatus of claim 1, wherein the object is clothing.

3. The apparatus of claim 2, wherein the clothing is underwear.

4. The apparatus of claim 1, wherein the object is dishware.

5. The apparatus of claim 1, wherein the object is bedding.

6. The apparatus of claim 5, wherein the bedding being sheets.

7. The apparatus of claim 1, wherein the object tag is underwear.

8. The apparatus of claim 1, wherein the object tag is comforter.

9. The apparatus of claim 1, wherein the object tag being a sticker.

10. The apparatus of claim 1, wherein the picture is an animal.

11. The apparatus of claim 11, wherein the picture is duck.

12. The apparatus of claim 1, wherein the picture being a stencil.

13. The apparatus of claim 1, wherein the word identifier is the word “blue”.

14. The apparatus of claim 11, wherein the word identifier is the word “duck”.

15. The apparatus of claim 1, wherein the word identifier being a stamp.

16. A method for educating children, the method comprising:
selecting an object;
selecting the word representing the object;
attaching the word representing the object on the object;
selecting a picture;
attaching the picture on the object;
selecting a word that represents the picture;
attaching the word onto the object, wherein the object being determined, the picture being determined.

17. The method of claim 16 wherein the object is boxers.

18. The method of claim 16 wherein the picture is of a duck.

19. The method of claim 16 wherein the word is “duck”.

20. The method of claim 16 wherein the object is dishware.
